(19) United States
(12) Patent Application Publication
(10) Pub. No.: US 2022/0064567 A1
(43) Pub. Date: Mar. 3, 2022

(54) Pre-blended candle wax product, method and kit for creating a candle or candle wax product

(71) Applicant: Lesley Lorene Sears, Fort Wayne, IN (US)

(72) Inventor: Lesley Lorene Sears, Fort Wayne, IN (US)

(21) Appl. No.: 17/010,127

(22) Filed: Sep. 2, 2020

(51) Int. Cl. C11C 5/00; C11C 5/02

(52) U.S. Cl. CPC C11C 5/004; C11C 5/008; C11C 5/023; C11C 5/006

(57) ABSTRACT

This invention relates to a pre-blended candle wax product, method and kit for quickly and easily pouring a candle or candle product. The product, method and kit may be used to offer an environmentally friendly option for re-pouring candle wax into a previously used candle container or any other suitable container.

### CROSS-REFERENCE TO RELATED APPLICATIONS

This application claims the benefit of provisional patent application Ser. No. 62/922,851, filed 2019 Sep. 3 by the present inventor.

### BACKGROUND—PRIOR ART

The following is a tabulation of some prior are that presently appears relevant:

U.S. patent Documents

| Pat. No. | Issue Date | Patentee |
|---|---|---|
| 6,171,103 | January 2001 | Orlandi |
| 6,347,756 | February 2002 | Dillard |
| 7,070,409 | July 2006 | Varrieur |
| 7,546,668 | June 2009 | Strelnieks |
| 10/519,399 | December 2019 | Campbell et al |

### BACKGROUND OF INVENTION

The present invention relates to a pre-blended candle wax product, method and kit used to easily, with no prior understanding or expertise in candle making, create and/or repour a fragranced candle or candle product.

By re-pouring candles back into their original containers, or repurposing other containers for the use of candles, they are made sustainable and much more eco-friendly.

Fragranced candles have become increasingly popular, with large numbers of people using them to fragrance their homes and other personal spaces. This increase in popularity, within a society that has become accustomed to a disposable lifestyle, has led to many empty candle containers being discarded and thrown away, ultimately ending up in the landfills.

These discarded candle containers are often made from glass containing lead, which disqualifies them from being recycled with other food grade glass products. This leaves few options when consumers are deciding how to dispose of their empty candle containers.

To address these environmental issues, some candle brands have created recycling programs for their glass containers, though any recycling program still emits environmental pollutants regardless of how diligent the recycling program is. When comparing a glass recycling program to the ability to reuse or repurpose containers from an environmental conscience perspective there is not comparison on which is more eco-friendly.

Other eco-friendly candle brands have focused on utilizing the candle container for other uses, such as including a label containing flower seeds that could then be planted in used container.

Another method of being eco-friendly that is being utilized within the candle industry is creating candle containers from more eco-friendly materials (such as clay or concrete) that will eventually decompose. However, those these attempts at making candles more eco-friendly are admirable, they are not utilizing the container for its intended purpose—as a candle.

There are also other candle making kits that include each individual element of the candle making process packaged separately within the kit. These kits include; raw wax, or waxes, fragrance oil or essential oil, candle dye, and wicks. This type of candle making kit requires a much higher degree of understanding of the technical aspects of candle making; ie. proper temperature for adding fragrance, proper way to blend wax and proper temperature and method for pouring. Possibly also requiring specialized candle making equipment, which could lead to user error and result in an inferior and possibly scentless candle.

In the present invention we are creating a pre-blended candle wax product, method and kit. This allows for usage of candle containers for their original purpose—candles. We are also providing the opportunity for other suitable containers to be repurposed into candles and remain sustainable as candles throughout their lifecycle.

### BRIEF DESCRIPTION OF DRAWINGS

FIG. 1 is pre-blended candle wax contained in a heat safe container.

FIG. 2 depicts a warming method for the pre-blended candle wax—that warms to pourable state but does not damage fragrance.

FIG. 3 depicts a kit of the present invention.

### DETAILED DESCRIPTION OF DRAWINGS

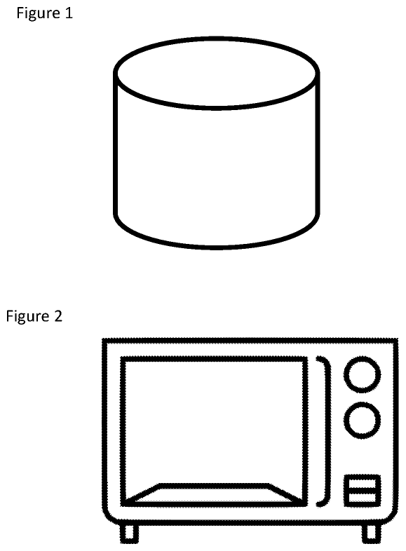

FIG. 1 is a heat safe container containing the pre-blended candle wax product. Heat safe container containing pre-blended candle wax is intended to be warmed to a pourable consistency and then used to create candles or candle type products

FIG. 2 is a microwave or other similar heating method which allows pre-blended candle wax to be warmed to a pourable state but does not damage the contained fragrance oil(s) and/or essential oil(s).

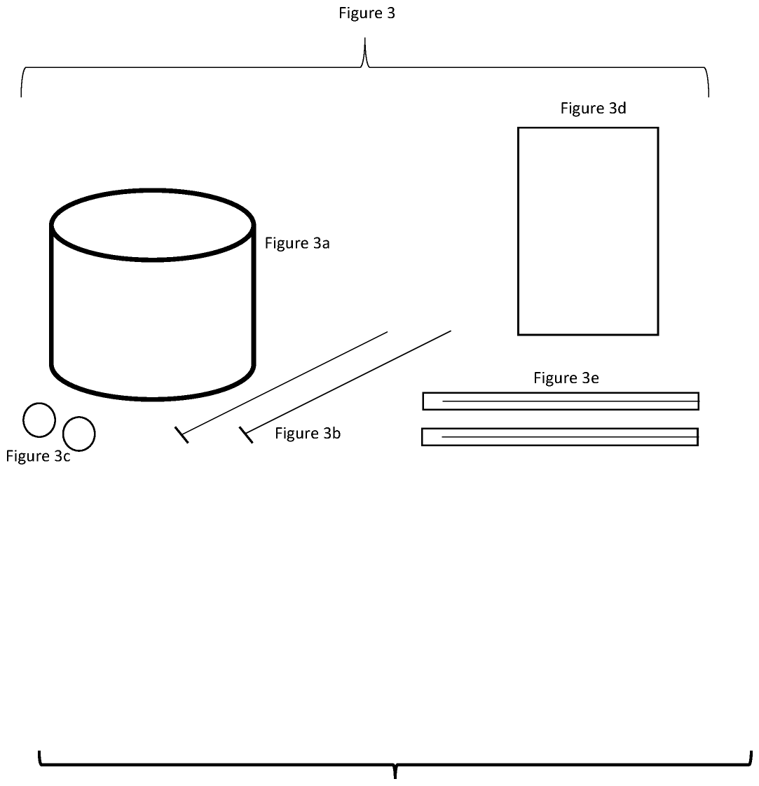

FIG. 3 depicts a kit of the present invention which includes: pre-blended candle wax mixture (FIG. 3a) contained in heat safe packaging (number of containers included in kit may vary with size of kit), wicks (FIG. 3b) (number of wicks included in kit may vary with size of kit), wick adhesive or stickers (FIG. 3c) (number of wick adhesive or stickers included may vary with size of kit), detailed instructions (FIG. 3d) (various methods of providing instructions are included in claims), wick stabilizers (FIG. 3e) (number of wick stabilizers included may vary with size of kit)

### SPECIFICATION

The present invention is a pre-blended candle wax product, method and kit that provides an eco-friendly alternative to traditional candles and candle products.

The present invention comprises: the pre-blended candle wax product contains natural wax(es) (either as a blend of waxes or with one individual type of wax), natural butters, oils, and other materials that have been properly blended achieving the appropriate temperatures, with fragrance oil(s) and/or essential oil(s) added at the proper temperature and poured into a microwavable and heat safe container.

This pre-blended candle wax can then be easily and quickly warmed in the microwave, or other suitable warming process, and then poured into the original candle container or into another repurposed container (such as an antique crock or other suitable container). This pre-blended candle wax can also alternately be used to create other candle type products depending on the type of pre-blended candle wax that is used. Candle or candle type products such as: container candle, taper candle, pillar candle, tart melt, and scoopable wax. All can be created with different wax blends of the pre-blended kit.

This pre-blending and gentle warming process ensures a properly blended candle with an acceptable fragrance throw to everyone creating the candle regardless of their technical skills in candle making.

With this pre-blended candle wax method, the technical aspects of candle making have already been completed; melting of wax (or wax blend) at proper temperature, adding butters, oils or other materials, incorporating fragrance oil(s) or essential oil(s) in the correct percentage at the correct temperature to ensure proper fragrance release have all been accomplished. Allowing the user to simply warm the pre-blended wax slightly and pour a perfectly fragranced and eco-friendly sustainable candle every time.

Embodiments of the present invention include pre-blended candle wax comprising: a variety of waxes (soy wax, paraffin wax, bee's wax, coconut wax, palm wax, bayberry wax, and gel wax); a variety of natural butters (shea butter, cocoa butter, and mango butter) which would be added to the wax blend; oils comprising of: olive oil, coconut oil, jojoba oil, hemp seed, and palm kernel would be added to the wax blend; materials to aid in fragrance release; materials to adjust hardness of blend (stearic acid); a variety of fragrance oil(s) and/or essential oil(s). Depending on the desired end candle or candle type product a blend of these materials would be used.

In one embodiment the pre-blended candle wax would be a blend of soy wax, coconut oil, stearic acid, and fragrance oil(s) and/or essential oil(s) with final blend designed to create a highly fragranced tart melt as the final product.

In another embodiment the wax blend may be soy wax and fragrance and/or essential oils with the final blend designed to create a container candle as the final product.

Another embodiment is a kit of the present invention which allows for re-pouring of previously burned and now empty candle containers eliminating the need to dispose of the container but simply re-pouring and continuing to use it. Alternate eco-friendly vessels for creating candles with this kit include antique and vintage containers that can be repurposed into candles.

Another embodiment of the kit includes wicks that are made of braided cotton, wood, paper core, or zinc core. Wick adhesive and stabilizers used would be those conducive to said wick materials.

A further embodiment of the kit may include instructions provided in the form of an html address which provides the steps of pouring the candle. The instructions may be provided in the form of an html address which includes a video demonstration of pouring the candle. The instructions may be provided in the form of an html address which includes an audio description of pouring the candle. The kit may include one or more photographs or drawing depicting one or more steps of pouring the candle. The kit may include written instructions describing one or more steps of pouring the candle.

We claim:

1. A pre-blended candle wax comprising: a natural wax(es); and fragrance oil(s) and/or essential oil(s), said pre-blended candle wax being developed to be easily rewarmed and poured to form a candle or candle type product by user, with said pre-blended candle wax having a melt temperature conducive to rewarming in a microwave or other method of heating so as to achieve a consistency that can be poured yet not damage said fragrance oil(s) and/or essential oil(s).

2. The pre-blended candle wax of claim 1 wherein said natural wax is combined with natural butters and/or oils.

3. The pre-blended candle wax of claim 1 wherein said natural wax is combined with material used to adjust (increase or decrease) release of fragrance oil(s) or essential oil(s).

4. The pre-blended candle wax of claim 1 wherein a color pigment is added.

5. The method of warming a pre-blended candle wax comprising: a natural wax; and fragrance oil(s) and/or essential oil(s), so as to achieve a pourable consistency but not to a temperature that would damage the included fragrance oil(s) and/or essential oil(s), this warming can be achieved within a microwave oven, or within alternative heating methods that can achieve a regulated warming of pre-blended candle wax.

6. A Kit for pouring a candle or candle type product comprising: a) a pre-blended candle wax contained in a heat safe container; b) candle wicks; c) candle wick adhesive to secure wicks to bottom of container; d) wick stabilizers; e) written or graphic instructions for use comprising the following steps: prepare container for candle by cleaning container; adhere wicks to bottom of container; add wick stabilizers to wicks either before or after pouring wax into container; warm natural wax blend in or out of container to a consistency of porridge (from 30 seconds to 7 minutes depending on heating device); pour warm pre-blended candle wax into prepared container; allow candle to cool; provide option of allowing fragrance to cure before burning candle.

7. The kit of claim 6 wherein kit contains wicks made from braided cotton, wood, paper core, or zinc core, including wick adhesive and stabilizers conducive to said wick material.

8. The kit of claim 6 wherein kit also contains a candle form or candle container.

9. The kit of claim 6 wherein the instructions are provided in the form of an html or other electronic address which provides the steps of creating the candle.

10. The kit of claim 6 wherein the instructions are provided in the form of an html or other electronic address which includes a video demonstration of creating the candle.

11. The kit of claim 6 wherein the instructions are provided in the form of an html or other electronic address which includes an audio of creating the candle.

12. The kit of claim 6 wherein the pre-blended candle wax is developed to create a container candle.

13. The kit of claim 6 wherein the pre-blended candle wax is developed to create a taper candle.

14. The kit of claim 6 wherein the pre-blended candle wax is developed to create a pillar candle.

15. The kit of claim 6 wherein the pre-blended candle wax is developed to create a wax tart.

16. The kit of claim 6 wherein the pre-blended candle wax is developed to create a scoopable (softer) wax product.
